(19) United States
(12) Patent Application Publication
(10) Pub. No.: US 2014/0348492 A1
(43) Pub. Date: Nov. 27, 2014

(54) RECORDING APPARATUS, DELIVERY APPARATUS, RECORDING METHOD, PROGRAM, AND RECORDING MEDIUM

(71) Applicant: Sharp Kabushiki Kaisha, Osaka-shi, Osaka (JP)

(72) Inventors: Shuichi Watanabe, Osaka-shi (JP); Maki Takahashi, Osaka-shi (JP)

(21) Appl. No.: 14/345,076

(22) PCT Filed: Sep. 19, 2012
(86) PCT No.: PCT/JP2012/073956

§ 371 Date: Mar. 14, 2014

(30) Foreign Application Priority Data
Sep. 28, 2011 (JP) 2011-213274

(51) Int. Cl. H04N 5/91; H04N 21/61

(52) U.S. Cl. CPC H04N 5/91; H04N 21/6112
USPC 386/326

(57) ABSTRACT

A recording apparatus (1) includes a receiving unit (11) configured to acquire a plurality of components forming content, and a recording unit (12) configured to select a recording method to record the content, configured to combine the plurality of components and then record the plurality of components on a recording medium (13) on a combination basis in a case that a first recording method has been selected, and configured to record the plurality of components on an individual basis in a case that a second recording method has been selected.

### TECHNICAL FIELD

The present invention relates to a recording apparatus that records content including a plurality of components and a recording method of the recording apparatus. The present invention also relates to a delivery apparatus that delivers to the recording apparatus the content including the plurality of components. The present invention also relates to a program that causes a computer to operate as the recording apparatus, and a recording medium having stored the program.

### BACKGROUND ART

With the widespread use of the Internet and increased performance of computers, a vast amount of content such as a moving image is increasingly delivered via the Internet. Digital terrestrial broadcasting is now in service, and broadcast content is digitized. Content delivery by broadcasting and content delivery by communication may be integrated.

Patent Literature 1 discloses a technique of integrating broadcast content and Internet content. Patent Literature 2 discloses a technique of adding Internet home page address information to broadcast content. Patent Literature 3 discloses a technique of integrating broadcast content, network content, and package media.

### CITATION LIST

### Patent Literature

PTL 1: Japanese Unexamined Patent Application Publication No. 2004-56274
PTL 2: Japanese Unexamined Patent Application Publication No. 2005-286748
PTL 3: Japanese Unexamined Patent Application Publication No. 10-173612

### SUMMARY OF INVENTION

### Technical Problem

Hybrid transmission has recently drawn attention in the field of content delivery. The hybrid transmission refers to a transmission system in which a plurality of components forming content is transmitted using a plurality of transmission channels, particularly, heterogeneous channels, such as a combination of broadcasting and communication.

The hybrid-transmitted components include some that are standalone reproducible and others that are standalone unreproducible. The hybrid-transmitted components also include reacquisition enabled components and reacquisition disabled components. If a hybrid-transmitted component is merely recorded, the content recorded may happen to be unreproducible in a state desired by a user (viewer) or a provider (deliverer).

The present invention has been developed in view of the above problem, and the object of the invention is to provide a recording apparatus that records content in a manner such that the content is reproduced in a state desired by the user (viewer) or the provider (deliverer).

### Solution to Problem

To solve the above problem, a recording apparatus of the present invention includes an acquisition unit configured to acquire a plurality of components forming content, a selection unit configured to select a recording method to record the content, and a recording unit configured to combine the plurality of components and then record the plurality of components on a combination basis in a case that the selection unit has selected a first recording method, and configured to record the plurality of components on an individual basis in a case that the selection unit has selected a second recording method.

To solve the above problem, a recording method of the present invention of a recording apparatus configured to record content, includes an acquisition step of acquiring a plurality of components forming the content, a selection step of selecting a recording method to record the content, and a recording step of combining the plurality of components and then recording the plurality of components on a combination basis in a case that a first recording method has been selected in the selection step, and recording the plurality of components on an individual basis in a case that a second recording method has been selected in the selection step.

The plurality of components forming the content may be recorded on a combination basis or may be recorded on an individual basis. The way to record the content is different depending on the intention of a user or a provider. The above arrangement allows the components to be selectively recorded on a combination basis or on an individual basis. If the selection is performed in response to an instruction from the user, the content may be reproduced in a state desired by the user subsequent to the recording of the content. If the selection is performed in response to an instruction from the provider, the content may be reproduced in a state desired by the provider subsequent to the recording of the content.

To solve the problem, a delivery apparatus of the present invention configured to deliver content including a plurality of components, includes a providing unit configured to provide a recording unit recording the content with recording method specifying information that specifies whether the plurality of components is to be recorded on a combination basis or to be recorded on an individual basis.

The delivery apparatus causes the recording apparatus to record and reproduce the content in a state desired by an operator, such as the provider of the delivery apparatus. Since the user is freed from an operation to select the recording method, the operation of the recording apparatus by the user is facilitated.

The recording apparatus of the present invention is implemented using a program. The program configured to cause a computer to operate as the recording apparatus of the present invention and a recording medium having stored such a program also fall within the scope of the present invention.

### Advantageous Effects of Invention

As described above, the recording apparatus of the present invention includes the acquisition unit configured to acquire the plurality of components forming the content, the selection unit configured to select the recording method to record the content, and the recording unit configured to combine the plurality of components and then record the plurality of components on a combination basis in a case that the selection unit has selected a first recording method, and configured to record the plurality of components on an individual basis in a case that the selection unit has selected a second recording method.

The recording method of the present invention is a recording method of a recording apparatus configured to record the content, includes the acquisition step of acquiring the plurality of components forming the content, the selection step of selecting a recording method to record the content, and the recording step of combining the plurality of components and then recording the plurality of components on the combination basis in a case that a first recording method has been selected in the selection step, and recording the plurality of components on the individual basis in a case that a second recording method has been selected in the selection step.

The recording apparatus of the present invention includes the acquisition unit configured to acquire recording method specifying information that specifies the recording method of the content.

The content is thus recorded in a manner such that the content is reproduced in a state desired by a user (viewer) or a provider (deliverer).

### BRIEF DESCRIPTION OF DRAWINGS

FIG. 1 is a block diagram illustrating a configuration of a recording apparatus of a first embodiment.

FIG. 2 is a block diagram illustrating a configuration of a recording apparatus of a second embodiment.

FIG. 3 is a block diagram illustrating a configuration of a recording apparatus of a third embodiment.

FIG. 4 is a block diagram illustrating a configuration of a recording apparatus of a fourth embodiment.

### DESCRIPTION OF EMBODIMENTS

### First Embodiment

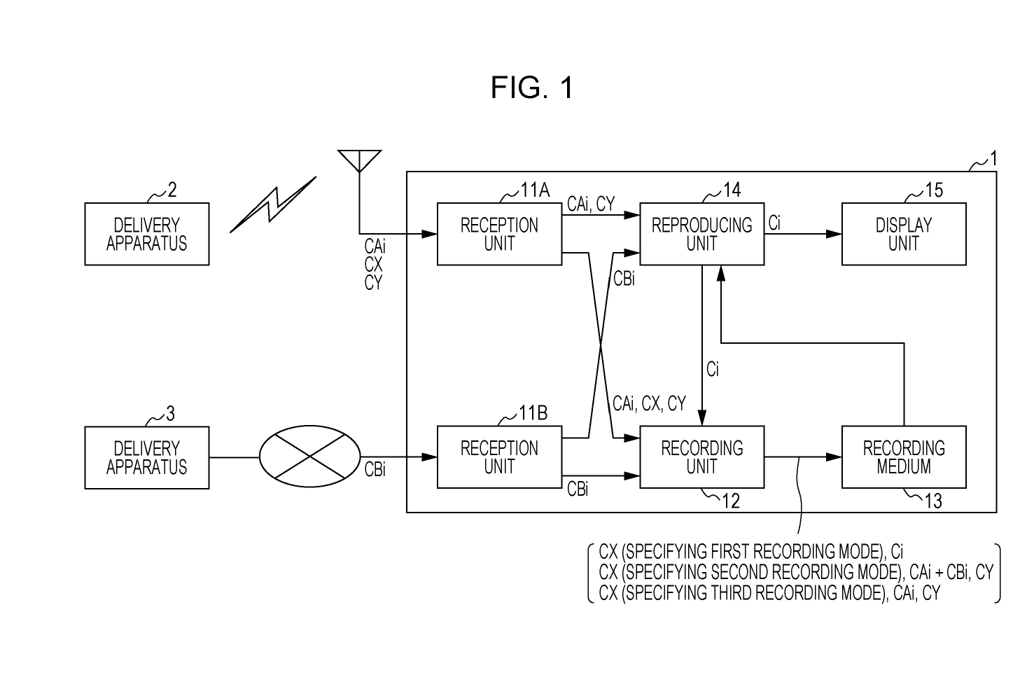

A recording apparatus 1 of a first embodiment of the present invention (hereinafter referred to as a “present embodiment”) is described with reference to FIG. 1. FIG. 1 is a block diagram illustrating a configuration of a recording apparatus 1 of the present embodiment.

The recording apparatus 1 records content C including a plurality of components. The components are delivered by one of a delivery apparatus 2 and a delivery apparatus 3. From among these components, components delivered by the delivery apparatus 2 are referred to as CA1, CA2, . . . , and components delivered by the delivery apparatus 3 are referred to as CB1, CB2, . . . .

In the present embodiment, the content C is a moving image that is scalable encoded. In the present embodiment, the components CA1, CA2, . . . , and CAn forming a base layer are delivered by the delivery apparatus 2 and the components CB1, CB2, CB3, . . . , and CBn forming an enhancement layer are delivered by the delivery apparatus 3. A component CAi is a base layer corresponding to period Ti. A component CBi is an enhancement layer corresponding to period Ti. During reproduction, the recording apparatus 1 reproduces the content Ci at a high-quality reproduction level corresponding to the period Ti (hereinafter referred to as a “scene Ci”) by referencing the component CAi and the component CBi.

If the content C is a moving image that is scalable encoded, components CAi/CBi are data (data stream) representing a base layer/enhancement layer of the content C. The present invention is not limited to this data. For example, if the content C is multimedia content including a plurality of elements (a moving image, a still image, audio, text and the like), the components CAi/CBi are data representing each element of such content C. In such a case, as well, the recording apparatus 1 reproduces the content C by synchronizing and combining the components CAi/CBi.

The delivery apparatus 2 broadcast delivers the components CA1, CA2, . . . , and CAn. The broadcast delivering of each component CAi is performed at a timing determined by the delivery apparatus 2 itself, regardless of a request from the recording apparatus 1. More specifically, the timing at which the recording apparatus 1 acquires each CAi is limited to a timing at which the delivery apparatus 2 broadcast delivers the component CAi. In the present embodiment, the broadcast delivering of the components CA1, CA2, . . . , and CAn is performed by broadcasting, such as digital terrestrial broadcasting.

The delivery apparatus 3 unicast delivers the components CB1, CB2, CB3, . . . , and CBn. The unicast delivering of each component CBi is performed in response to a request from the recording apparatus 1 (output by an unillustrated transmission unit). More specifically, the recording apparatus 1 may determine any timing to be the timing at which the recording apparatus 1 acquires each component CBi, namely, the timing at which the recording apparatus 1 requests the component CBi. The unicast delivering of the components CB1, CB2, CB3, . . . , and CBn may be performed via communication, such as TCP/IP communication.

The recording apparatus 1 records the content C in one of three modes. In a first recording mode, content data of the content C subsequent combination (in this embodiment, after decoding process and reproduction process are performed on the base layer CA and the enhancement layer CB) is recorded. In a second recording mode, both the components CA1, CA2, . . . , and CAn and the components CB1, CB2, CB3, . . . , and CBn, prior to the combination, are recorded. In a third recording mode, only the components CA1, CA2, . . . , and CAn are recorded prior to the combination. If the content C is recorded in the third recording mode, the components CB1, CB2, CB3, . . . , and CBn are acquired during reproduction as described below. In the following discussion, the first recording mode is also referred to as “content recording method” (first recording method). The second and third recording modes are also referred to as a “component recording method” (second recording method).

In the present embodiment, the delivery apparatus 2 delivers recording mode specifying information (recording method specifying information) CX specifying a recording mode to be selected by the recording apparatus 1, together with the components CA1, CA2, . . . , and CAn. In other words, the delivery apparatus 2 includes a providing unit that provides the recording apparatus 1 with the recording mode specifying information. By referencing the recording mode specifying information CX, the recording apparatus 1 selects the recording mode to record the content C. The delivery apparatus 2 also delivers configuration information (mutual relationship information) CY indicating a mutual relationship among the components CA1, CA2, . . . , CAn, CB1, CB2, CB3, . . . , and CBn, together with the components CA1, CA2, . . . , and CAn.

In a case that the content C is scalable encoded multimedia content, the configuration information CY specifies a data stream (the component CAi) of a base layer and a data stream (the component CBi) of an enhancement layer in each scene Ci. In other words, as for the component CAi (the data stream of the base layer), the configuration information CY specifies the CBi corresponding to that component CAi (the data stream of the enhancement layer having a dependent relationship with the component CAi). The present invention is not limited to this information CY. More specifically, if the content C is multimedia content including a plurality of elements (such as a moving image, a still image, audio, or text), the configuration information CY specifies an element forming a scene Ci as well as specifying location of video elements (such as a moving image, a still image, or text), and an exclusive relationship of audio elements (such as voice).

In a case that the components CB1, CB2, CB3, . . . , and CBn are acquired via a different path, the configuration information CY may further include information indicating a delivery source (here the delivery apparatus 3) that may request the components CB1, CB2, CB3, . . . , and CBn to be transmitted (hereinafter referred to as “delivery source information”). It is sufficient if the delivery source information described in the configuration information CY indicates a delivery source (such as a provider that may acquire a necessary component) of the component necessary for reproduction. For example, the delivery source information described in the configuration information CY may correspond to the path over which the component is provided. Also, the delivery source information described in the configuration information CY may include information indicating delivery sources of the components CA1, CA2, . . . , and CAn and the components CB1, CB2, CB3, . . . , and CBn (the delivery apparatuses 2 and 3 herein).

By referencing the configuration information CY, the recording apparatus 1 learns that the components to be referenced for reproducing the content Ci are CAi and CBi. The recording apparatus 1 may acquire the components CAi and CBi from the information of the delivery source described in the configuration information CY.

Referring to FIG. 1, the recording apparatus 1 includes a reception unit (acquisition unit) 11A, a reception unit (acquisition unit) 11B, a recording unit (selection unit or recording unit) 12, a recording medium 13, a reproducing unit 14, and a display unit 15. In the present embodiment, the recording apparatus 1 includes the recording medium 13 and the display unit 15. The present invention is not limited to this configuration. For example, the recording apparatus 1 may include detachably installed recording medium and display unit in place of the recording medium 13 and the display unit 15.

The reception unit 11A acquires the components CA1, CA2, . . . , and CAn from the delivery apparatus 2, and is a tuner, for example. The reception unit 11A includes an unillustrated buffer, and stores a received component CAi on the buffer for a predetermined period of time. The reception unit 11A receives the recording mode specifying information CX and the configuration information CY from the delivery apparatus 2. Optionally, the recording mode specifying information CX may be included in the configuration information CY. In other words, the reception unit 11A may receive the configuration information CY including the recording mode specifying information CX.

The recording mode specifying information CX received by the reception unit 11A is transferred to the recording unit 12 as well as being recorded on the recording medium 13 in preparation for reference during non-real time reproduction. The configuration information CY received by the reception unit 11A is recorded on the recording medium 13 in preparation for reference during non-real time reproduction except that a first recording mode is specified in the recording mode specifying information CX. The term non-real time reproduction refers to reproduction subsequent to recording, and is used as opposed to real time reproduction.

The reception unit 11B acquires the components CB1, CB2, CB3, . . . , and CBn delivered by the delivery apparatus 3, and is a wireless LAN module, for example. A timing at which the reception unit 11B acquires the component CBi, namely, a timing at which the recording apparatus 1 references the configuration information CY and requests the component CBi to be delivered, is a timing at which the reception unit 11A has acquired (namely, recorded) the component CAi or a timing at which the content Ci recorded in a third recording mode is reproduced on a non-real time basis. The reception unit 11B also includes an unillustrated buffer, and stores a received component CBi for a predetermined period of time.

The recording unit 12 selects the recording mode used to record the content C by referencing the recording mode specifying information CX supplied from the reception unit 11A. (1) If the first recording mode is selected, the recording unit 12 records on the recording medium 13 content data representing the content Ci combined by the reproducing unit 14. (2) If the second recording mode is selected, the recording unit 12 records on the recording medium 13 the component CAi received by the reception unit 11A and the component CBi received by the reception unit 11B. (3) If the third recording mode is selected, the recording unit 12 records on the recording medium 13 only the component CAi received by the reception unit 11A.

A communication failure may cause the component CBi to be temporarily unavailable. If the component CBi is not acquired with the first recording mode selected, the recording unit 12 records on the recording medium 13 content data representing the content Ci reproduced from only the component CAi. If the component CBi is not acquired with the second recording mode selected, the recording unit 12 acquires the component CBi later at an appropriate timing and then records the component CBi on the recording medium 13. The recording unit 12 acquires the component CBi at the appropriate timing in one of the following cases: (1) the component CBi is acquired immediately subsequent to the restoration of communication after the communication failure, (2) the component CBi is acquired during a time band in which a sufficient bandwidth is typically available, for example, during night time (in such a case, another component CBj that has remained to be acquired may also be acquired together for the same reason), (3) the component CBj is acquired during a time band specified by a client (the recording apparatus 1) or a server (the delivery apparatuses 2 and 3) (in this case as well, the other component CBj that has remained to be acquired may be also acquired together for the same reason).

The reproducing unit 14 performs real-time reproduction and non-real-time reproduction on the content C. If the real-time reproduction is to be performed, the reproducing unit 14 reproduces the content Ci by combining the component CAi read from the buffer of the reception unit 11A and the component CBi read from the buffer of the reception unit 11B. The content Ci combined by the reproducing unit 14 is then transferred to the display unit 15 and the recording unit 12. The display unit 15 displays the content Ci combined by the reproducing unit 14.

On the other hand, the non-real-time reproduction is to be performed, the reproducing unit 14 identifies the recording mode in which the content C has been recorded, by referencing the recording mode specifying information CX recorded on the recording medium 13. (1) If the content C has been recorded in the first recording mode, the reproducing unit 14 reproduces the content Ci from the content data read from the recording medium 13. (2) If the content C has been recorded in the second recording mode, the reproducing unit 14 reproduces the content Ci by combining the component CAi and the component CBi read from the recording medium 13. In this case, information of the configuration information CY indicating the mutual relationship is referenced. (3) If the content C has been recorded in the third recording mode, the recording apparatus 1 requests from the delivery apparatus 3 the component CBi by referencing the delivery source information of the configuration information CY. The reproducing unit 14 reproduces the content Ci by combining the component CAi read from the recording medium 13 and the component CBi newly received and read from the buffer of the reception unit 11B. In this case, the reproducing unit 14 identifies the component CAi and the component CBi to be referenced to reproduce the content Ci by referencing the information of the configuration information CY, recorded on the recording medium 13, indicating the mutual relationship.

In the present embodiment, a scalable encoded moving image is a recording target. The recording target is not limited to the moving image. For example, the recording target may include a 3D moving image (stereoscopic moving image). In such a case, it is contemplated that the delivery apparatus 2 broadcast delivers a component forming a left-eye image (main image) and that the delivery apparatus 3 broadcast delivers a component forming a right-eye image (sub image). In the same manner as performed in the digital terrestrial broadcasting, the delivery apparatus 2 may broadcast deliver a component forming a program image, and the delivery apparatus 3 may unicast deliver a component including additional information (description of a program, recommended program similar to the program, advertisement, news, weather forecasting, and the like).

In a case that the component is not used on a standalone basis subsequent to recording, for example, the first recording mode is appropriate on the above recording targets as described below. More specifically, the first recording mode is appropriate in a case that the reproduction of base layer data alone of scalable encoded video content is disabled subsequent to recording or in a case that replacement of additional information or other information is explicitly inhibited on real-time-only video content subsequent to recording.

In a case that the component is used on a standalone basis subsequent to recording, the second recording mode is appropriate on the above recording targets as described below. More specifically, the second recording mode is appropriate in a case that the reproduction of the base layer data alone of the scalable encoded video content is enabled subsequent to recording (the usage where only the base layer data is retrieved onto a mobile terminal is also assumed) or in a case that the component includes video content and related information of the video content (a type of the additional information) and the component is viewed with the related information switchably on/off displayed subsequent to recording.

In a case that there is a need or a request to replace the component during reproduction subsequent to recording, the third recording mode is appropriate as described below. More specifically, the third recording mode is appropriate in a case that an appropriate reproduction component, such as a CM or a trailer, varies with time and location, and is replaced as appropriate. Replacement component includes local information, such as weather forecast, and commentary information that may change from hour to hour.

The content is recorded in accordance with the recording mode in response to the content. The content is thus reproduced in a state desired by the user (viewer) or the provider (deliverer).

In accordance with the present embodiment, the components CA1, CA2, . . . , and CAn are delivered through broadcast delivery by broadcasting. The delivery scheme of the components CA1, CA2, . . . , and CAn is not limited to broadcast delivery by broadcasting. More specifically, the components CA1, CA2, . . . , and CAn may be delivered through broadcast delivery by communication (in simultaneous broadcast communication) instead of broadcast delivery by broadcasting. As long as any delivery scheme delivers the components CA1, CA2, . . . , and CAn in a form that does not allow the components CA1, CA2, . . . , and CAn to be reacquired, the present invention is advantageous in the delivery scheme.

In accordance with the present embodiment, the unicast delivery by communication is adopted to deliver the components CB1, CB2, CB3, . . . , and CBn. The delivery scheme of the components CB1, CB2, CB3, . . . , and CBn is not limited to the unicast delivery by communication. More specifically, the components CB1, CB2, CB3, . . . , and CBn may be delivered through multicast delivery by communication (though limited to on-demand multicast delivery) instead of unitcast delivery by communication. As long as any delivery scheme delivers the components CB1, CB2, CB3, . . . , and CBn in a form that allows the components CB1, CB2, CB3, . . . , and CBn to be reacquired (with the acquisition enabled during the non-real-time reproduction), the present invention is applicable in the delivery scheme without any difficulty.

In the present embodiment, the delivery apparatus 2 delivers the recording mode specifying information CX and the configuration information CY together with the components CA1, CA2, . . . , and CAn. The delivery of the recording mode specifying information CX and the configuration information CY is not limited to this delivery configuration. For example, the delivery apparatus 3 may deliver the recording mode specifying information CX and the configuration information CY together with the components CB1, CB2, CB3, . . . , and CBn instead of the delivery form in which the delivery apparatus 2 delivers the recording mode specifying information CX and the configuration information CY together with the components CA1, CA2, . . . , and CAn. Alternatively, a third delivery apparatus different from the delivery apparatus 2 and the delivery apparatus 3 may deliver the recording mode specifying information CX and the configuration information CY. However, in a case that the configuration information CY is delivered through delivery scheme other than through broadcasting (the delivery apparatus 2), the recording apparatus 1 is unable to request the component if the recording apparatus 1 has no knowledge of the communication related to the configuration information CY (the delivery of the component). In such a case, a trigger to start the communication through broadcasting (the delivery apparatus 2) may be separately transmitted. Alternatively, the configuration information CY and the recording mode specifying information CX may be respectively delivered by the delivery apparatus 2 and the delivery apparatus 3, or vice versa. The delivery timings of the recording mode specifying information CX and the configuration information CY are not bound by the delivery timings of the components CA1, CA2, . . . , and CAn and the components CB1, CB2, CB3, . . . , and CBn. More specifically, either one or both of the recording mode specifying information CX and the configuration information CY may be delivered prior to the delivery of the components CA1, CA2, . . . , CAn, CB1, CB2, CB3, . . . , and CBn, followed by the delivery of the components CA1, CA2, . . . , CAn, CB1, CB2, CB3, . . . , and CBn.

### Second Embodiment

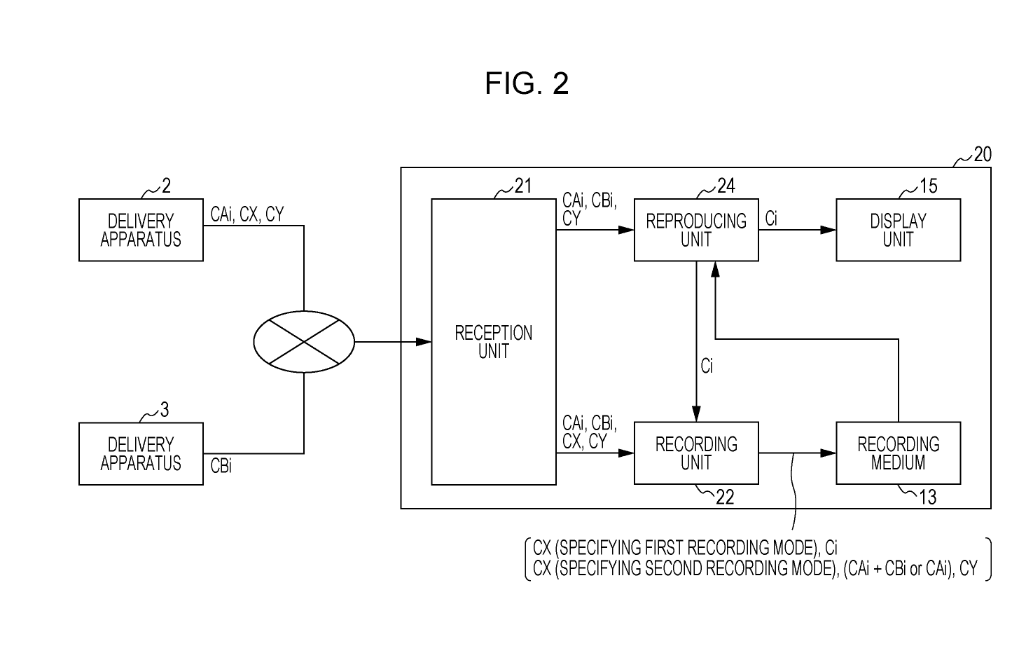

A recording apparatus 20 of a second embodiment of the present invention (hereinafter referred to as a “present embodiment”) is described with reference to FIG. 2. FIG. 2 is a block diagram illustrating a configuration of the recording apparatus 20 of the present embodiment. In the same manner as with the previous embodiment, the same elements are designated with the same reference numerals, and the discussion thereof is omitted herein.

As in the first embodiment, the recording apparatus 20 records the content C including a plurality of components. As in the first embodiment, the components may be delivered by one of the delivery apparatus 2 and the delivery apparatus 3. From among these components, components delivered by the delivery apparatus 2 are referred to as CA1, CA2, . . . , and components delivered by the delivery apparatus 3 are referred to as CB1, CB2, . . . .

As in the first embodiment, the content C is a moving image that is scalable encoded. In the present embodiment, the components CA1, CA2, . . . , and CAn forming a base layer are delivered by the delivery apparatus 2 and the components CB1, CB2, CB3, . . . , and CBn forming an enhancement layer are delivered by the delivery apparatus 3. A component CAi is a base layer corresponding to period Ti. A component CBi is an enhancement layer corresponding to period Ti.

The recording apparatus 20 of the present embodiment performs adaptation to reproduction quality in the real-time reproduction of the content C. More specifically, if a bandwidth of an available communication band is equal to or above a predetermined threshold value, the recording apparatus 20 reproduces the content Ci at a high-quality level by acquiring both the component CAi and the component CBi. On the other hand, if the bandwidth of the available communication band is equal to or below the predetermined threshold value, the recording apparatus 20 reproduces the content Ci at a low-quality level by acquiring only the component CAi. This determination is performed every period Ti. In this way, the reproduction of the content C continues without interruption even if the bandwidth of the available communication band varies. The correspondence relationship of CAi and CBi is indicated by the configuration information CY. The recording apparatus 20 receives the configuration information CY during real-time reception or any time point prior to the real-time reception, and determines based on the configuration information CY whether to acquire both CAi and CBi or only CAi (to stop requesting CBi).

The delivery apparatus 2 broadcast delivers the components CA1, CA2, . . . , and CAn. The delivering of each CAi is performed at a timing determined by the delivery apparatus 2 without a request from the recording apparatus 20. More specifically, the timing at which the recording apparatus 20 is enabled to acquire each component CAi is limited to the timing at which the delivery apparatus 2 broadcast delivers the component CAi. The present embodiment is based on the assumption that the broadcast delivering of the components CA1, CA2, . . . , and CAn is performed through communication, such as TCP/IP communication.

The delivery apparatus 3 unicast delivers the components CB1, CB2, CB3, . . . , and CBn. The delivering of each CBi is performed in response to a request from the recording apparatus 20. The request is determined based on the configuration information CY and is triggered at the real-time reproduction or any timing subsequent to recording. More specifically, the configuration information CY includes information indicating the delivery apparatus 3 that is enabled to request the component CBi at the real-time reproduction or subsequent to recording. In the present embodiment, the unicast delivering of the components CB1, CB2, CB3, . . . , and CBn is performed using communication, such as the TCP/IP communication.

As illustrated in FIG. 2, the delivery apparatus 2 and the delivery apparatus 3 are different apparatuses. Alternatively, a single unitary delivery apparatus may deliver the components CA1, CA2, . . . , CAn, CB1, CB2, CB3, . . . , and CBn.

The recording apparatus 20 records the content C in one of two recording modes. In a first recording mode, the content data representing the combined content C is recorded. Since the adaptation of the reproduction quality is performed in the present embodiment, the combined content C includes a mixture of the period Ti with the high-quality reproduction enabled (corresponding to the period in which the acquisition/recording of the component CBi is executed) and the period Tj with the high-quality reproduction disabled (corresponding to the period in which the acquisition/recording of the component CBj is canceled). In a second recording mode, the components CA1, CA2, . . . , and CAn and the components CB1, CB2, CB3, . . . , and CBn prior to combination are recorded on an individual basis. Note that the component CBi the acquisition of which is canceled by the adaptation is not recorded on the recording medium 13, and is acquired by the reception unit 21 during the non-real-time reproduction. In the following discussion, the first recording mode is also referred to as a “content recording method” (first recording method). The second recording mode is also referred to as a “component recording method” (second recording method).

In the present embodiment, the delivery apparatus 2 delivers the recording mode specifying information CX specifying the recording mode to be selected by the recording apparatus 20, together with the components CA1, CA2, . . . , and CAn. The recording apparatus 20 selects the recording mode to record the content C by referencing the recording mode specifying information CX. The delivery apparatus 2 also delivers the configuration information CY indicating the mutual relationship of the components CA1, CA2, . . . , CAn, CB1, CB2, CB3, . . . , and CBn, together with the components CA1, CA2, . . . , and CAn. By referencing the configuration information CY, the recording apparatus 20 learns that the component to be referenced to reproduce the content Ci is CAi and CBi.

As illustrated in FIG. 2, the recording apparatus 20 includes a reception unit 21, a recording unit 22, a recording medium 13, a reproducing unit 24, and a display unit 15. In the present embodiment, the recording apparatus 20 includes the recording medium 13 and the display unit 15. The present invention is not limited to this configuration. For example, the recording apparatus 20 may include detachably installed recording medium and display unit in place of the recording medium 13 and the display unit 15.

The reception unit 21 acquires the components CA1, CA2, . . . , and CAn from the delivery apparatus 2, and acquires the components CB1, CB2, CB3, . . . , and CBn from the delivery apparatus 3. For example, the reception unit 21 is a wireless LAN module. The reception unit 21 includes an unillustrated buffer, and stores received components CAi and CBi on the buffer for a predetermined period of time. The reception unit 21 receives the recording mode specifying information CX and the configuration information CY from the delivery apparatus 2. If the recording mode specifying information CX is included in the configuration information CY, the reception unit 21 receives the configuration information CY including the recording mode specifying information CX. More specifically, the recording mode specifying information CX and the configuration information CY may be received in unitary data. The recording mode specifying information CX received by the reception unit 21 is transferred to the recording unit 22 as well as being recorded on the recording medium 13 in preparation for reference during non-real time reproduction. The configuration information CY received by the reception unit 21 is recorded on the recording medium 13 in preparation for reference during non-real time reproduction except that the first recording mode is specified in the recording mode specifying information CX.

The timing at which the reception unit 21 acquires the component CBi is the timing at which the content Ci is received and real-time reproduced, and the timing at which the content Ci recorded in the second recording mode is non-real-time reproduced.

The recording unit 22 selects the recording mode used to record the content C by referencing the recording mode specifying information CX supplied from the reception unit 21. (1) If the first recording mode is selected, the recording unit 22 records on the recording medium 13 content data representing the content Ci reproduced by the reproducing unit 24. (2) If the second recording mode is selected, the recording unit 22 records on the recording medium 13 the component CAi and the component CBi received by the reception unit 21. If the acquisition of the component CBi is canceled by the adaptation, only the component CAi is recorded on the recording medium 13. Referring to FIG. 2, both of the component CAi and the component CBi or only the component CAi is recorded together with the recording mode specifying information CX specifying the second recording mode. This is intended to mean that both of the component CAi and the component CBi or only the component CAi is recorded during the same period Ti. If the adaptation is performed, there occurs a period during which both the component CAi and the component CBi are recorded, and a period during which only the component CAi is recorded. The components are thus recorded during the periods thereof throughout an overall reproduction period.

The reproducing unit 24 performs real-time reproduction and non-real-time reproduction on the content C. If the real-time reproduction is to be performed, the reproducing unit 24 reproduces the content Ci at a high-quality level by combining the component CAi and the component CBi read from the buffer of the reception unit 21. During the period in which the acquisition of the component CBi is canceled because of the adaptation, the reproducing unit 24 reproduces the content Ci at a low-quality level from only the component CAi read from the buffer of the reception unit 21. The content Ci combined by the reproducing unit 24 is transferred to the display unit 15 and the recording unit 22. The display unit 15 displays the content Ci combined by the reproducing unit 24.

On the other hand, if the non-real-time reproduction is to be performed, the reproducing unit 24 identifies the recording mode in which the content C has been recorded, by referencing the recording mode specifying information CX recorded on the recording medium 13. (1) If the content C has been recorded in the first recording mode, the reproducing unit 24 reproduces the content Ci from the content data read from the recording medium 13. (2) If the content C has been recorded in the second recording mode, the reproducing unit 24 reproduces the content Ci at a high-quality level by combining the component CAi and the component CBi read from the recording medium 13. During the period in which the component CBi is not recorded on the recording medium 13 (namely, during the period in which the acquisition of the component CBi is canceled because of the adaptation), the reproducing unit 24 requests the component CBi from the delivery apparatus 3 and the reception unit 21 then receives the component CBi. The reproducing unit 24 reproduces the content Ci at a high-quality level by combining the component CBi read from the buffer of the reception unit 21 and the component CAi read from the recording medium 13. In this case, the reproducing unit 24 identifies the component CAi and the component CBi to be referenced to reproduce the content Ci by referencing the configuration information CY recorded on the recording medium 13.

The component that needs to be acquired during the non-real-time reproduction is only the component CBi. If the bandwidth of the communication band is expected to be narrow during the non-real-time reproduction, the component CBi may be acquired in advance of the non-real-time reproduction when a sufficient bandwidth of the communication band is available or the component CBi may be acquired in advance by taking necessary communication time. This arrangement controls the occurrence of a fault during the non-real-time reproduction. The component CBi may be acquired in a case that a necessary bandwidth is available, or during night time, in which a possibility of bandwidth availability is typically high. Also, for example, the delivery apparatus 2, the delivery apparatus 3 or the recording apparatus 20 may specify the time band for acquisition.

In the present embodiment, a scalable encoded moving image is a recording target. The recording target is not limited to this content. For example, the recording target may be content in a case that only a left-eye video (main image) is received with the delivery of a right-eye video (sub image) temporarily suspended when the bandwidth is narrowed in the 3D moving image transmission, or may be content in a case that the delivery of commentary video (additional video) is temporarily suspended when the bandwidth is narrowed in a delivery dependent addition service. The delivery dependent addition service displays the commentary video of a movie director in a movie video in a picture-in-picture fashion.

In the present embodiment, the delivery apparatus 2 delivers the components CA1, CA2, . . . , and CAn through the broadcast delivery by communication. The delivery scheme of the components CA1, CA2, . . . , and CAn is not limited to the broadcast delivery by communication. More specifically, the components CA1, CA2, . . . , and CAn may be delivered through the multicast delivery by communication or the broadcast delivery by broadcasting instead of delivering the components CA1, CA2, . . . , and CAn through the broadcast delivery by communication. As long as any delivery scheme delivers the components CA1, CA2, . . . , CAn, CB1, CB2, CB3, . . . , and CBn in a delivery form that allows the components CA1, CA2, . . . , CAn, CB1, CB2, CB3, . . . , and CBn to be adapted, the present invention is advantageous in the delivery scheme.

In the present embodiment, the delivery apparatus 3 delivers the components CB1, CB2, CB3, . . . , and CBn through the unicast delivery by communication. The delivery scheme of the components CB1, CB2, CB3, . . . , and CBn is not limited to the unicast deliver by communication. The components CB1, CB2, CB3, . . . , and CBn may be delivered through the multicast delivery by communication (limited to the on-demand multicast delivery) instead of in the unicast delivery by communication. As long as any delivery scheme delivers the components CB1, CB2, CB3, . . . , and CBn in a delivery form that allows the components CB1, CB2, CB3, . . . , and CBn to be reacquired (in a form that allows the components to be acquired during the non-real-time reproduction), the present invention is advantageous in the delivery scheme.

In the present embodiment, the delivery apparatus 2 delivers the recording mode specifying information CX and the configuration information CY together with the components CA1, CA2, . . . , and CAn. The delivery of the recording mode specifying information CX and the configuration information CY is not limited to this delivery configuration. For example, the delivery apparatus 3 may deliver the recording mode specifying information CX and the configuration information CY. Alternatively, a third delivery apparatus different from the delivery apparatus 2 and the delivery apparatus 3 may deliver the recording mode specifying information CX and the configuration information CY. The configuration information CY and the recording mode specifying information CX may be respectively delivered by the delivery apparatus 2 and the delivery apparatus 3, or vice versa. The delivery timings of the recording mode specifying information CX and the configuration information CY are not bound by the delivery timings of the components CA1, CA2, . . . , and CAn and the components CB1, CB2, CB3, . . . , and CBn. More specifically, either one or both of the recording mode specifying information CX and the configuration information CY may be delivered prior to the delivery of the components CA1, CA2, . . . , CAn, CB1, CB2, CB3, . . . , and CBn, followed by the delivery of the components CA1, CA2, . . . , CAn, CB1, CB2, CB3, . . . , and CBn.

### Third Embodiment

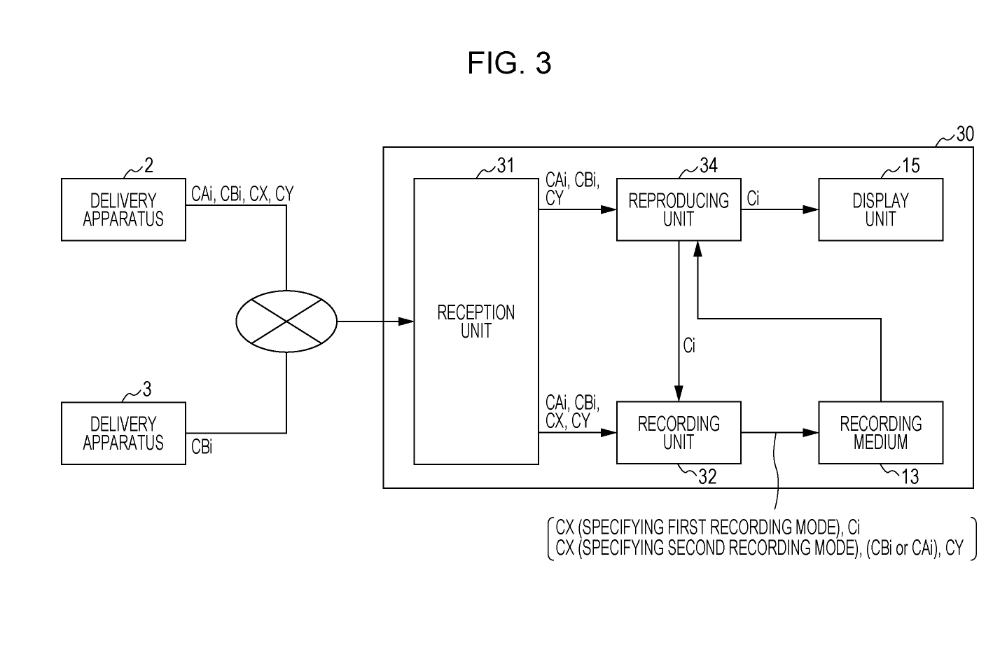

A recording apparatus 30 of a third embodiment of the present invention (hereinafter referred to as a “present embodiment”) is described with reference to FIG. 3. FIG. 3 is a block diagram illustrating a configuration of the recording apparatus 30 of the present embodiment. Elements identical those described in the previous embodiments are designated with the same reference numerals and the discussion thereof is omitted herein.

As with the recording apparatus 20 of the second embodiment, the recording apparatus 30 records the content C including a plurality of components, and performs adaptation on the content C when the content C is reproduced on a real-time basis.

A component CA and a component CB forming the content C are different from the counterparts thereof in the first embodiment. The component CA and the content CB are of the same content but different in compression rate. More specifically, the component CA and the content CB are different from each other in reproduction quality. The components CA1, CA2, . . . , and CAn having a high compression rate (having a low reproduction quality) are delivered from the delivery apparatus 2, and the components CB1, CB2, CB3, . . . , and CBn having a low compression rate (having a high reproduction quality) are delivered from the delivery apparatus 2 and the delivery apparatus 3. The component CAi is a component corresponding to a period Ti, and is high in compression rate, low in bit rate, and low in reproduction quality. The component CBi is a component corresponding to the period Ti, and is low in compression rate, high in bit rate, and high in reproduction quality.

The recording apparatus 30 of the present embodiment, when receiving the content C from the delivery apparatus 2 on a real-time basis, adapts the content C for reproduction quality. If the bandwidth of the available communication band is equal to or above a predetermined threshold value, the recording apparatus 30 reproduces the content Ci at a high-quality level by acquiring the component CBi having a high bit rate. On the other hand, if the bandwidth of the available communication band is equal to or below the predetermined threshold value, the recording apparatus 30 reproduces the content Ci at a low-quality level by acquiring the component CAi having a low bit rate. This determination is performed every period Ti. In this way, the reproduction of the content C continues without interruption even if the bandwidth of the available communication band varies. The configuration information CY indicates the mutual relationship of CAi and CBi. The recording apparatus 30 receives the configuration information CY during real-time reception or any time point prior to the real-time reception, and determines based on the configuration information CY whether to acquire CAi or CBi.

The delivery apparatus 2 unicast delivers the components CA1, CA2, . . . , and CAn, and the components CB1, CB2, CB3, . . . , and CBn. The delivering of the components CAi and CBi is performed in response to a request from the recording apparatus 30. The request is determined based on the configuration information CY and triggered at the real-time reproduction. For this reason, the configuration information CY includes information indicating the delivery apparatus 2 that is enabled to request the component CAi or the component CBi at the real-time reproduction (information indicating the delivery source of the component CAi or CBi). In the present embodiment, the unicast delivering of the components CA1, CA2, . . . , CAn, CB1, CB2, CB3, . . . , and CBn is performed through communication, such as the TCP/IP communication.

The delivery apparatus 3 unicast delivers the components CB1, CB2, CB3, . . . , and CBn. The delivering of each CBi is performed in response to a request from the recording apparatus 30. The request is determined based on the configuration information CY and is triggered at any timing subsequent to the real-time reproduction and recording. More specifically, the configuration information CY includes information indicating the delivery apparatus 3 that is enabled to request the component CBi subsequent to recording (the information indicating the delivery source of the component CBi). In the present embodiment, the unicast delivering of the components CB1, CB2, CB3, . . . , and CBn is performed through communication, such as the TCP/IP communication.

As illustrated in FIG. 3, the delivery apparatus 2 and the delivery apparatus 3 are different apparatuses. Alternatively, a single unitary delivery apparatus may deliver the components CA1, CA2, . . . , CAn, CB1, CB2, CB3, . . . , and CBn as appropriate. In other words, the delivery apparatus 2 may perform the delivery operation during the real-time reproduction and the delivery operation subsequent to the real-time reproduction and recording.

The recording apparatus 30 records the content C in one of two recording modes. In a first recording mode, the content data representing the combined content C received during the real-time reproduction is recorded while the configuration information CY is not recorded. Since the adaptation of the reproduction quality is performed in the present embodiment, the combined content C received on a real-time basis includes a mixture of the period Ti with the high-quality reproduction enabled (corresponding to the period in which the acquisition/recording of the component CBi is executed) and the period Tj with the high-quality reproduction disabled (corresponding to the period in which the acquisition/recording of the component CAj is executed). Further in the first recording mode, the received components CA and CB are not discriminated from each other subsequent to recording, and the component data may be recorded in a concatenated state or may be recorded as the data of the reconverted content C after being reproduced on the reproducing unit 34. In a second recording mode, the components CA1, CA2, . . . , and CAn and the components CB1, CB2, CB3, . . . , and CBn, received on a real-time basis, are recorded on an individual basis (CAi or CBi is recorded during the period Ti), and the configuration information CY is also recorded together with CAi or CBi. A high-bit rate component CBi that is not acquired because of adaptation is not recorded on the recording medium 13 (in such a case, CAi is recorded). During the non-real time reproduction, the reception unit 31 acquires CBi by referencing the configuration information CY. In the following discussion, the first recording mode is also referred to as a “content recording method” (first recording method). The second recording mode is also referred to as a “component recording method” (second recording method).

In the present embodiment, the delivery apparatus 2 delivers the recording mode specifying information CX specifying a recording mode to be selected by the recording apparatus 30, together with the components CA1, CA2, . . . , CAn, CB1, CB2, CB3, . . . , and CBn. By referencing the recording mode specifying information CX, the recording apparatus 30 selects the recording mode to record the content C. The delivery apparatus 2 also delivers configuration information CY indicating a mutual relationship among the components CA1, CA2, . . . , CAn, CB1, CB2, CB3, . . . , and CBn, together with the components CA1, CA2, . . . , CAn, CB1, CB2, CB3, . . . , and CBn. By referencing the configuration information CY, the recording apparatus 30 learns that the components to be referenced to reproduce the content Ci are CAi and CBi (CAi or CBi).

As illustrated in FIG. 3, the recording apparatus 30 includes a reception unit 31, a recording unit 32, a recording medium 13, a reproducing unit 34, and a display unit 15. In the present embodiment, the recording apparatus 30 includes the recording medium 13 and the display unit 15. The present invention is not limited to this configuration. For example, the recording apparatus 30 may include detachably installed recording medium and display unit in place of the recording medium 13 and the display unit 15.

The reception unit 31 acquires the components CA1, CA2, . . . , CAn, CB1, CB2, CB3, . . . , and CBn from the delivery apparatus 2, and acquires the components CB1, CB2, CB3, . . . , and CBn from the delivery apparatus 3. For example, the reception unit 31 is a wireless LAN module. The reception unit 31 includes an unillustrated buffer, and stores received component CAi or CBi on the buffer for a predetermined period of time. The reception unit 31 receives the recording mode specifying information CX and the configuration information CY from the delivery apparatus 2. If the recording mode specifying information CX is included in the configuration information CY, the reception unit 31 may receive the configuration information CY including the recording mode specifying information CX. The recording mode specifying information CX received by the reception unit 31 is transferred to the recording unit 32 as well as being recorded on the recording medium 13 in preparation for reference during non-real time reproduction. The configuration information CY received by the reception unit 31 is recorded on the recording medium 13 in preparation for reference during the non-real time reproduction except that the first recording mode is specified in the recording mode specifying information CX.

The timing at which the reception unit 31 acquires the component CBi is the timing at which the content Ci is received and real-time reproduced (the content Ci is acquired from the delivery apparatus 2), and the timing at which the content Ci recorded in the second recording mode is non-real-time reproduced (the content Ci is acquired from the delivery apparatus 3).

The recording unit 32 selects the recording mode used to record the content C by referencing the recording mode specifying information CX supplied from the reception unit 31. (1) If the first recording mode is selected, the recording unit 32 records on the recording medium 13 content data representing the content Ci reproduced by the reproducing unit 34 (as described above, the content data can be data resulting from simply concatenating the received components CAi and CBj). (2) If the second recording mode is selected, the recording unit 32 records separately on the recording medium 13 the component CAi or the component CBi received by the reception unit 31 together with the configuration information CY. Referring to FIG. 3, the component CAi or the component CBi is recorded together with the recording mode specifying information CX specifying the second recording mode. This is intended to mean that the component CAi or the component CBi is recorded during the same period Ti. If the adaptation is performed, there occur a period during which the component CAi is recorded, and a period during which the component CBi is recorded. The components are thus recorded during the periods thereof throughout overall reproduction period.

The reproducing unit 34 performs real-time reproduction and non-real-time reproduction on the content C. If the real-time reproduction is to be performed, the reproducing unit 34 reproduces the content Ci at a high-quality level based on the component CBi read from the buffer of the reception unit 31. During the period in which the component CAi is acquired through the adaptation, the reproducing unit 34 reproduces at a low-quality level the component CAi read from the buffer of the reception unit 31. The content Ci combined by the reproducing unit 34 is transferred to the display unit 15 and the recording unit 32. The display unit 15 displays the content Ci combined by the reproducing unit 34.

On the other hand, the non-real-time reproduction is to be performed, the reproducing unit 34 identifies the recording mode in which the content C has been recorded, by referencing the recording mode specifying information CX recorded on the recording medium 13. (1) If the content C has been recorded in the first recording mode, the reproducing unit 34 reproduces the content Ci from the content data read from the recording medium 13. (2) If the content C has been recorded in the second recording mode, the reproducing unit 34 reproduces the content Ci at a high-quality level based on the recorded component CBi of the content Ci read from the recording medium 13, during the period in which the component CBi is recorded. The period in which the component CBi is not recorded on the recording medium 13 (in other words, the period in which the component CAi is acquired via the adaptation and recorded), the reproducing unit 34 requests the component CBi from the delivery apparatus 3, and then reproduces the content Ci at a high-quality level using the component CBi read from the buffer of the reception unit 31 and newly received. The reproducing unit 34 identifies the component CBi to be referenced to reproduce the content Ci and the delivery source of the component CBi by referencing the configuration information CY recorded on the recording medium 13.

The component that needs to be acquired during the non-real-time reproduction is only the component CBi. If the bandwidth of the communication band is expected to be narrow during the non-real-time reproduction, the component CBi may be acquired in advance of the non-real-time reproduction when a sufficient bandwidth of the communication band is available or the component CBi may be acquired in advance by taking necessary communication time. This arrangement controls the occurrence of a fault during the non-real-time reproduction. The component CBi may be acquired in a case that a necessary bandwidth is available, or during night time, in which a possibility of bandwidth availability is typically high. Also, for example, the delivery apparatus 2, the delivery apparatus 3 or the recording apparatus 30 may specify the time band for acquisition.

In the present embodiment, the recording target is a moving image that is adaptation delivered as coded data different in compression rate and in bit rate. The recording target is not limited to such content. For example, the recording target may be content that is simultaneously delivered using broadcasting with a low error tolerance and a high bit rate (such as full-segment broadcasting) and broadcasting with a high error tolerance and a low bit rate (such as one-segment broadcasting). In such a case, the adaptation of the reproduction quality may be performed by receiving the content via the broadcasting with a low error tolerance and a high bit rate if receiving sensitivity is above a predetermined threshold value, or by receiving the content via the broadcasting with a high error tolerance and a low bit rate if receiving sensitivity is equal to or below the predetermined threshold value. The component to be delivered via the broadcasting with a low error tolerance and a high bit rate may also be delivered through communication. In such a case, the adaptation of the reproduction quality may be performed by switching to acquire through the communication the component that is to be delivered via the broadcasting with a high error tolerance and a low bit rate if receiving sensitivity is equal to or below the predetermined threshold value. If the second recording mode is selected, the component having a high error tolerance and a low bit rate, received through the broadcasting or the communication, is replaced with the component having a low error tolerance and a high bit rate, acquired through the communication in response to a new request, and the component having a low error tolerance and a high bit rate is reproduced on a non-real-time basis. The present embodiment is applicable to applications where content is appropriately adaptation delivered depending on variations of the bandwidth. Such content may include low-quality components CA1, CA2, . . . , and CAn in which a pair of video and sound is multiplexed, and high-quality components CB1, CB2, CB3, . . . , and CBn in which a plurality of videos (a first video channel, a second video channel, and the like), a plurality of sounds (a first sound, a second sound, and the like), or a multiple types of related data is multiplexed.

In the present embodiment, the delivery apparatus 2 delivers the components CA1, CA2, . . . , CAn, CB1, CB2, CB3, . . . , and CBn through unicast delivery. The delivery configuration of the components CA1, CA2, . . . , CAn, CB1, CB2, CB3, . . . , and CBn is not limited to the unicast delivery. More specifically, the components CA1, CA2, . . . , CAn, CB1, CB2, CB3, . . . , and CBn may be delivered through multicast delivery by communication or broadcast delivery by broadcasting instead of delivering the components the components CA1, CA2, . . . , CAn, CB1, CB2, CB3, . . . , and CBn through the unicast delivery by communication. As long as any delivery scheme delivers the components CA1, CA2, . . . , CAn, CB1, CB2, CB3, . . . , and CBn in a delivery form that allows the components CA1, CA2, . . . , CAn, CB1, CB2, CB3, . . . , and CBn to be adapted, the present invention is advantageous in the delivery scheme.

In accordance with the present embodiment, the delivery apparatus 3 delivers the components CB1, CB2, CB3, . . . , and CBn through the unicast delivery by communication. The delivery of the components CB1, CB2, CB3, . . . , and CBn is not limited to the unicast delivery by communication. More specifically, the components CB1, CB2, CB3, . . . , and CBn may be delivered using the multicast delivery by communication (though limited to on-demand multicast delivery) instead of the unitcast delivery by communication. As long as any delivery scheme delivers the components CB1, CB2, CB3, . . . , and CBn in a form that allows the components CB1, CB2, CB3, . . . , and CBn to be reacquired (with the acquisition enabled during the non-real-time reproduction), the present invention is applicable on the delivery scheme without any difficulty.

In the present embodiment, the delivery apparatus 2 delivers the recording mode specifying information CX and the configuration information CY together with the components CA1, CA2, . . . , CAn, CB1, CB2, CB3, . . . , and CBn. The delivery of the recording mode specifying information CX and the configuration information CY is not limited to this delivery configuration. Alternatively, a third delivery apparatus different from the delivery apparatus 2 and the delivery apparatus 3 may deliver the recording mode specifying information CX and the configuration information CY. Alternatively, the configuration information CY and the recording mode specifying information CX may be respectively delivered by the delivery apparatus 2 and the delivery apparatus 3, or vice versa. The delivery timings of the recording mode specifying information CX and the configuration information CY are not bound by the delivery timings of the components CA1, CA2, . . . , and CAn and the components CB1, CB2, CB3, . . . , and CBn. More specifically, either one or both of the recording mode specifying information CX and the configuration information CY may be delivered prior to the delivery of the components CA1, CA2, . . . , CAn, CB1, CB2, CB3, . . . , and CBn, followed by the delivery of the components CA1, CA2, . . . , CAn, CB1, CB2, CB3, . . . , and CBn.

### Fourth Embodiment

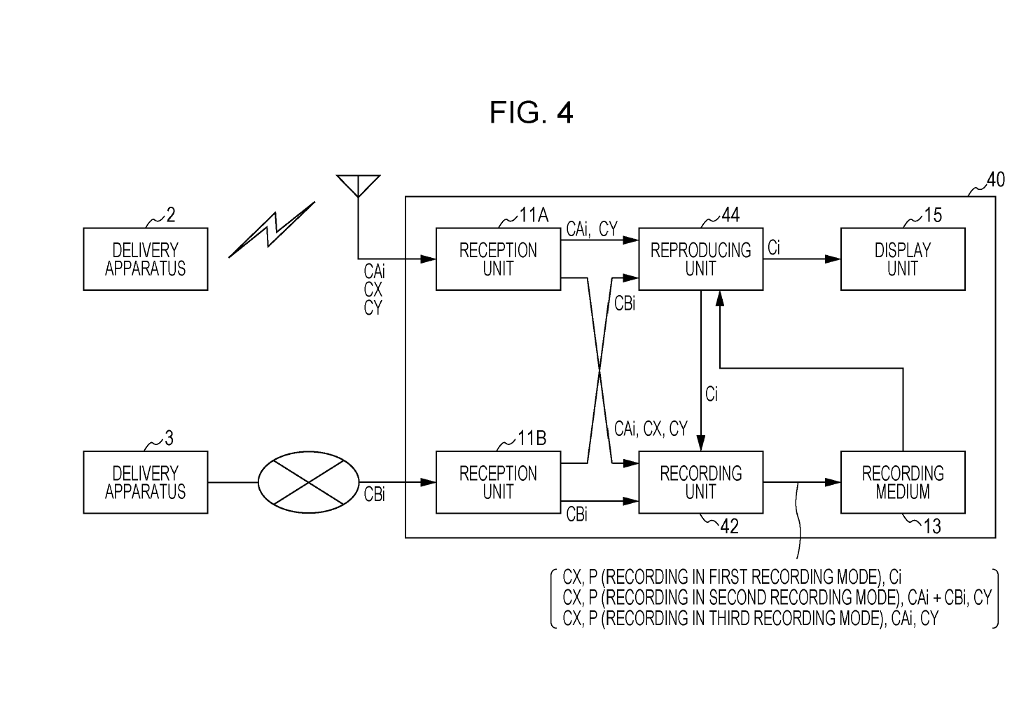

A recording apparatus 40 of a fourth embodiment of the present invention (hereinafter referred to as a “present embodiment”) is described with reference to FIG. 4. FIG. 4 is a block diagram illustrating a configuration of the recording apparatus 40 of the present embodiment. In the same manner as with the previous embodiments, the same elements are designated with the same reference numerals, and the discussion thereof is omitted.

As in the first embodiment, the recording apparatus 40 records the content C including a plurality of components. Instead of selecting the recording mode based on the recording mode specifying information CX only, the recording apparatus 40 selects the recording mode (1) with the user's own decision additionally accounted for, (2) with the user's own decision only accounted for, (3) in response to the user's own instruction, or (4) in response to prior setting.

As in the first embodiment, the components may be delivered by one of the delivery apparatus 2 and the delivery apparatus 3. From among these components, components delivered by the delivery apparatus 2 are referred to as CA1, CA2, . . . , and components delivered by the delivery apparatus 3 are referred to as CB1, CB2, . . . .

As in the first embodiment, the content C is a moving image that is scalable encoded. In the present embodiment, the components CA1, CA2, . . . , and CAn forming a base layer are delivered by the delivery apparatus 2 and the components CB1, CB2, CB3, . . . , and CBn forming an enhancement layer are delivered by the delivery apparatus 3. A component CAi is a base layer corresponding to period Ti. A component CBi is an enhancement layer corresponding to period Ti.

As illustrated in FIG. 4, the recording apparatus 40 includes reception units 11A and 11B, a recording unit 42, a recording medium 13, a reproducing unit 44, and a display unit 15.

The recording unit 42 determines whether the content C is recordable in the recording mode specified in the recording mode specifying information CX supplied from the reception unit 11. More specifically, the recording unit 42 performs this determination based on the specifications thereof (such as throughput and permissible storage capacity), communication environment (such as bandwidth and receiving sensitivity), and other factors. If it is determined that the content C is recordable, the recording unit 42 records the content C in the recording mode specified in the recording mode specifying information CX. On the other hand, if it is determined that the content C is not recordable, the recording unit 42 records the content C in a recording mode different from the recording mode specified in the recording mode specifying information CX.

If it is determined that the reception of both the component CAi and the component CBi is difficult even after the first recording mode is specified in the recording mode specifying information CX in the first embodiment, the recording unit 42 records the content C in the third recording mode. Even if it is difficult to reproduce the content C at a high-quality level on a real-time basis, high-quality reproduction of the content C is performed on a non-real-time basis.

More specifically, even if the recording mode specifying information specifies the first recording mode, the content C is not recorded in the method specified in the recording mode specifying information (the content recording form of the first embodiment) in a case that the remaining recording capacity of the recording medium 13 is equal to or below a rated value (or it is difficult to record the content C because of insufficient capacity to record all the components CAi and CBi). The recording unit 42 switches to the method to record only the component CAi and the configuration information CY (the component recording form of the first embodiment or more in detail, the third recording method). As for the communication environment, the content C is not recorded in the method specified in the recording mode specifying information (in the content recording form) when the communication is temporarily disconnected, and the recording unit 42 switches to the method to record only the component CAi and the configuration information CY, transmitted via the broadcasting (in the component recording form).

In each of these specific examples, the recording operation that only the component CAi and the configuration information CY have been recorded in the component recording method (recorded in the third recording method) is recorded as process information P. The process information P may have the same form as that of the recording mode specifying information CX.

The recording unit 42 updates the recording form in response to an input operation of the user. For example, the component recording form may now be specified in the recording mode specifying information CX. If the user expects no operation to reproduce the content C on a component-by-component basis subsequent to recording (expects no operation to reproduce the base layer CAi only) and specifies the content recording form (the first recording method) on a combination basis using an unillustrated input unit, the recording unit 42 records the content C in accordance with the user's instruction regardless of the recording mode specifying information CX. The use of the first recording mode makes unnecessary the configuration information and management information incidental to the component, leading to an advantage of reduced amount of recorded data. In this case, the recording operation that the content C has been recorded in the first recording mode is recorded as the process information P. The process information P may have the same form as that of the recording mode specifying information CX.

Similarly, the content C may be recorded in the second recording mode in a case that the second recording mode in the first embodiment (the recording mode to record both CAi and CBi from among the component recording forms) is not specified in the recording mode specifying information CX. The process information P indicating the recording operation performed in the second recording mode is recorded.

A recording mode to the user's preference (or of a default setting) may be registered in the recording apparatus 40 (recorded on the recording medium 13) in advance. The recording unit 42, when recording the delivered component, selects the registered recording mode.

If it is difficult to acquire the recording mode specifying information, the recording unit 42 may select a recording mode based on only the determination thereof. For example, the recording unit 42 may select an appropriate recording mode, based on the specifications of the recording apparatus 40 (such as throughput and permissible storage capacity), communication environment (such as bandwidth and receiving sensitivity), attribute information incidental to the component, and configuration information. A recording mode to the user's preference (or of a default setting) may be registered in advance, and if the recording mode specifying information is not available, the registered recording mode is selected.

As the reproducing unit 14 of the first embodiment, the reproducing unit 44 performs real-time reproduction and non-real-time reproduction on the content C. Note that the recording unit 42 records the process information P in the present embodiment. For this reason, if the process information P is stored on the recording medium 13 the reproducing unit 44 references the process information P to verify the form of the content recorded on the recording medium 13. The reproducing unit 44 identifies the component CAi and the component CBi to be referenced to reproduce the content Ci by referencing the content Ci subsequent to combination or the configuration information CY.

If the recording apparatus 40 is configured to select a recording mode different from the recording mode specified in the recording mode specifying information CX in this way, a configuration to upload recording mode information indicating the selected recording mode from the recording apparatus 40 to the delivery apparatus 3 (and/or the delivery apparatus 2) may be incorporated together. The recording mode information may be the process information P. In this way, the delivery apparatus 3 (and/or the delivery apparatus 2) determines whether a component supplemental to a component recorded by the recording apparatus 40 is present or not, and thus re-delivers the supplemental component at an appropriate timing or at a reproduction timing. The appropriate timing may be the timing of the determination described above, in a time band set by the delivery apparatus 3 (the delivery apparatus 2), or in a time band, such as night time, typically having a bandwidth availability. Alternatively, the recording apparatus 40 may specify the time band. It is sufficient if the timing is the one the delivery apparatus 3 (the delivery apparatus 2) or the recording apparatus 40 determines to be appropriate. Note that the delivery apparatus 2 of FIG. 4 is based on the assumption that the content C is delivered through broadcasting. The content C is not delivered in response to each recording apparatus 40 on an individual basis. For example, the present embodiment is based on the following example in which the delivery apparatus 2 summarizes the process information P transmitted from each recording apparatus 40 (via a different channel such as communication channel), determines a component having a high need of supplement, and then re-delivers (re-broadcasts) the component using a broadcast wave. For example, the re-delivery at the reproduction timing may be executed in the following example in which the recording apparatus 40 transmits the process information P at the recording instead of transmitting a request for an actual component in a case that the recording apparatus 40 issues a request to the delivery apparatus 3 during the non-real-time reproduction, and the recording apparatus 40 thus causes the delivery apparatus 3 to determine the component to be transmitted.

### CONCLUSION

As described above, the recording apparatus described in the specification includes an acquisition unit configured to acquire a plurality of components forming content, a selection unit configured to select a recording method to record the content, and a recording unit configured to combine the plurality of components and then record the plurality of components on a combination basis in a case that the selection unit has selected a first recording method, and configured to record the plurality of components on an individual basis in a case that the selection unit has selected a second recording method.

A recording method described in the specification is related to a recording method of the recording apparatus configured to record content, includes an acquisition step of acquiring a plurality of components forming the content, a selection step of selecting a recording method to record the content, and a recording step of combining the plurality of components and then recording the plurality of components on a combination basis in a case that a first recording method has been selected in the selection step, and recording the plurality of components on an individual basis in a case that a second recording method has been selected in the selection step.

The plurality of components forming the content may be recorded on a combination basis or on an individual basis. Which way to use for the appropriate recording of the content depends on the intention of the user or the provider. The arrangement described above provides an option to select between recording the content on a combination basis and recording the content on an individual basis. In particular to perform the selection in response to the instruction from the user, the content is ready to be reproduced in a state desired by the user after the content is recorded. To perform the selection in response to the instruction from the provider, the content is ready to be reproduced in a state desired by the provider after the content is recorded.

In the recording apparatus described in the specification, preferably, the acquisition unit further acquires recording method specifying information that specifies the recording method of the content, and the selection unit selects the recording method specified in the recording method specifying information.

The arrangement described above allows the content to be reproduced in a state desired by a setter of the recording mode specifying information, such as the provider, after the content is recorded on the recording apparatus. Since the arrangement frees the user from any operation to select the recording method, the user may operates the recording apparatus in a simplified manner.

In the recording apparatus described in the specification, preferably, the acquisition unit acquires mutual relationship information that indicates a mutual relationship among the plurality of components, and is referenced to combine the plurality of components, and the recording unit records the mutual relationship information together with the plurality of components in a case that the selection unit has selected the second recording method.

The arrangement described above allows the content recorded in the second recording method to be reproduced on a combination basis later.

In the recording apparatus described in the specification, the plurality of components includes a reacquisition enabled component and a reacquisition disabled component and the recording unit records each of the reacquisition disabled components on an individual basis in a case that the selection unit has selected the second recording method.

The arrangement described above reacquires the reacquisition enabled component later and allows the content recorded on the recording apparatus to be reproduced on a combination basis later (during non-real-time reproduction). The term “reacquisition” is intended to mean acquisition of a component subsequent to the real-time reproduction. The “reacquisition” includes acquiring at any timing subsequent to the real-time reproduction a component that the acquisition unit failed to acquire (or did not acquire) during the real-time reproduction.

In the recording apparatus described in the specification, preferably, the plurality of components includes a low-quality reproduction component and a high-quality reproduction component, and the acquisition unit determines whether to acquire the high-quality component in response to a state of a channel in a case that the content is to be recorded, and then acquires a high-quality reproduction component that has not been acquired in a case that the content is to be reproduced.

The arrangement described above acquires the high-quality reproduction component during the reproduction in a case that the high-quality reproduction component was not acquired during the recording. The content is thus reproduced at a high-quality reproduction level.

In the recording apparatus described in the specification, preferably, the selection unit determines whether to select the recording method specified in the recording method specifying information based on a state of a channel or a state of the recording apparatus, and then selects a recording method different from the recording method specified in the recording method specifying information in a case that the selection unit has determined that the recording method specified in the recording method specifying information is not to be selected. In a case that the selection unit has selected the recording method different from the recording method specified in the recording method specifying information, the recording unit further records information indicating the different recording method.

Depending on the state of the channel or the state of the recording apparatus, the arrangement described above determines whether to select the recording method specified in the recording method specifying information. If it is determined that the recording method is not selected, then the selection unit selects the recording method different from the recording method specified in the recording method specifying information. In this way, if the recording method different from the recording method specified in the recording method specifying information is not appropriate for the state of the channel or the state of the recording apparatus, an appropriate recording method is applicable.

The arrangement described above further records the information indicating the different recording method if the recording method different from the recording method specified in the recording method specifying information is selected. By referencing the information, the recording apparatus performs appropriate reproduction responsive to the actual recording method.

A delivery apparatus described in the specification configured to deliver content including a plurality of components, includes a providing unit configured to provide a recording unit configured to record the content with recording method specifying information that specifies whether the plurality of components is to be recorded on a combination basis or to be recorded on an individual basis.

The arrangement described above causes the recording apparatus to record and then reproduce the content in a state desired by an operator of the delivery apparatus, such as the provider. Since the arrangement frees the user from any operation to select the recording method, the user may operate the recording apparatus in a simplified manner.

The recording apparatus described in the specification is implemented using a program. The program configured to cause a computer to operate as the recording apparatus of the present invention and a recording medium storing the program fall within the scope of the present invention.

### INDUSTRIAL APPLICABILITY

The present invention is appropriately applicable to recording content that is transmitted in a hybrid transmission system.

### REFERENCE SIGNS LIST

1, 20, 30, and 40 Recording apparatuses
11A, 11B, 21, and 31 Reception units (acquisition units)
12, 22, 32, and 42 Recording units (selection units and recording units)
13 Recording medium
14, 24, 34, and 44 Reproducing units
15 Display unit
2 and 3 Delivery apparatuses
C and Ci Content
CA1, CA2, Components
CB1, CB2, Components
CX Recording mode specifying information (recording method specifying information)
CY Configuration information (mutual relationship information)
P Process information

1. A recording apparatus comprising:
an acquisition unit configured to acquire a plurality of components forming content,
a selection unit configured to select a recording method to record the content, and
a recording unit configured to combine the plurality of components and then record the plurality of components on a combination basis in a case that the selection unit has selected a first recording method, and configured to record the plurality of components on an individual basis in a case that the selection unit has selected a second recording method.

2. The recording apparatus according to claim 1, wherein the acquisition unit further acquires recording method specifying information that specifies the recording method of the content, and
wherein the selection unit selects the recording method specified in the recording method specifying information.

3. The recording apparatus according to claim 1, wherein the acquisition unit acquires mutual relationship information that indicates a mutual relationship among the plurality of components, and is referenced to combine the plurality of components, and
wherein the recording unit records the mutual relationship information together with the plurality of components in a case that the selection unit has selected the second recording method.

4. The recording apparatus according to claim 1, wherein the plurality of components includes a reacquisition enabled component and a reacquisition disabled component and wherein the recording unit records each of the reacquisition disabled components on an individual basis in a case that the selection unit has selected the second recording method.

5. The recording apparatus according to claim 1, wherein the plurality of components comprises a low-quality reproduction component and a high-quality reproduction component, and
wherein the acquisition unit determines whether to acquire the high-quality component in response to a state of a channel in a case that the content is to be recorded, and then acquires a high-quality reproduction component that has not been acquired in a case that the content is to be reproduced.

6. The recording apparatus according to claim 2, wherein the selection unit determines whether to select the recording method specified in the recording method specifying information based on a state of a channel or a state of the recording apparatus, and then selects a recording method different from the recording method specified in the recording method specifying information in a case that the selection unit has determined that the recording method specified in the recording method specifying information is not to be selected, and
wherein in a case that the selection unit has selected the recording method different from the recording method specified in the recording method specifying information, the recording unit further records information indicating the different recording method.

7. The recording apparatus according to claim 1, wherein the acquisition unit acquires recording method specifying information that specifies the recording method of the content, and mutual relationship information that indicates a mutual relationship among the plurality of components, and is referenced to combine the content,
wherein the selection unit selects the recording method specified in the recording method specifying information, and
wherein the recording unit records the mutual relationship information together with the plurality of components in a case that the selection unit has selected the second recording method.

8. A delivery apparatus configured to deliver content including a plurality of components, comprising
a providing unit configured to provide a recording unit configured to record the content with recording method specifying information that specifies whether the plurality of components is to be recorded on a combination basis or to be recorded on an individual basis.

9. A recording method of a recording apparatus configured to record content, comprising:
an acquisition step of acquiring a plurality of components forming the content,
a selection step of selecting a recording method to record the content, and
a recording step of combining the plurality of components and then recording the plurality of components on a combination basis in a case that a first recording method has been selected in the selection step, and recording the plurality of components on an individual basis in a case that a second recording method has been selected in the selection step.

10. (canceled)

11. A non-transitory computer readable recording medium storing a program configured to cause a computer to operate as the recording apparatus according to claim 1, the computer to function as each of the units included in the recording apparatus.
